(19) United States
(12) Patent Application Publication
(10) Pub. No.: US 2026/0100487 A1
(43) Pub. Date: Apr. 9, 2026

(54) NONAQUEOUS ELECTROLYTE SOLUTION BATTERY LEAD WIRE AND NONAQUEOUS ELECTROLYTE SOLUTION BATTERY

(71) Applicant: SUMITOMO ELECTRIC INDUSTRIES, LTD., Osaka (JP)

(72) Inventors: Yutaka MATSUMURA, Osaka (JP); Kengo GOTO, Osaka (JP); Satoshi YASUI, Osaka (JP); Yusuke KUREISHI, Osaka (JP)

(73) Assignee: SUMITOMO ELECTRIC INDUSTRIES, LTD., Osaka (JP)

(21) Appl. No.: 19/109,607

(22) PCT Filed: Sep. 9, 2022
(86) PCT No.: PCT/JP2022/033901

§ 371 Date: Mar. 7, 2025

(51) Int. Cl. H01M 50/534; H01M 50/571; H01M 50/586; H01M 50/591

(52) U.S. Cl. CPC H01M 50/534; H01M 50/571; H01M 50/586; H01M 50/591

(57) ABSTRACT

A nonaqueous electrolyte solution battery lead wire of the present disclosure includes a conductor and an insulating film having one or a plurality of layers and covering at least part of an outer peripheral surface of the conductor. The conductor has a conductor film covering at least part of a surface thereof, the conductor film contains a trivalent chromium compound including chromium hydroxide and a metal element, a ratio of a mass of chromium contained in the chromium hydroxide per unit area [mg/m²] to a mass of chromium contained in the trivalent chromium compound per unit area [mg/m²] is 0.30 to 0.90 at an outermost surface of the conductor film, the insulating film has an innermost layer stacked on a surface of the conductor film, the innermost layer contains, as a main component, a resin component including maleic anhydride-modified polypropylene.

### TECHNICAL FIELD

The present disclosure relates to a nonaqueous electrolyte solution battery lead wire and a nonaqueous electrolyte solution battery.

### BACKGROUND ART

As electronic devices become smaller and lighter, there is a demand for downsizing and weight reduction of electrical components such as batteries and capacitors used in these devices. Thus, for example, nonaqueous electrolyte solution batteries using a pouch as an enclosing container, in which nonaqueous electrolyte solution, a positive electrode, and a negative electrode are enclosed inside, have been adopted. As the nonaqueous electrolyte solution, an electrolyte solution in which a fluorine-containing nonaqueous such as LiPF₆ or LiBF₄ is dissolved in propylene carbonate, ethylene carbonate, dimethyl carbonate, diethyl carbonate, ethyl methyl carbonate, or the like is used.

The enclosing container is required to have a property of preventing permeation of an electrolyte solution and gas and entry of moisture from the outside. Thus, a laminate film in which a metal layer such as an aluminum foil is coated with a resin is used as a material of the enclosing container, and the ends of two laminate films are heat-sealed to form the enclosing container.

One end of the enclosing container is opened, and a nonaqueous electrolyte solution, a positive electrode plate, a negative electrode plate, a separator, and the like are enclosed inside the container. Further, a lead conductor connected at one end thereof to the positive electrode plate and the negative electrode plate is disposed so as to extend from the inside to the outside of the enclosing container, and finally, the opening portion is heat-sealed to close the opening portion of the enclosing container, and the enclosing container and the lead conductor are bonded to seal the opening portion. The portion that is finally heat-sealed is called a seal portion.

A portion of the lead conductor corresponding to the seal portion is covered with an insulating film, and a lead wire including the insulating film and the lead conductor is called a nonaqueous electrolyte solution battery lead wire (tab lead). The enclosing container and the lead conductor are bonded (heat-sealed) to each other through the insulating film. Thus, the insulating film is required to have a property of maintaining the adhesive between the lead conductor and the enclosing container without causing short-circuiting between the metal layer of the enclosing container and the lead conductor.

As the tab lead, for example, a nonaqueous electrolyte battery including a lead wire in which different metals are used for a conductor of a lead wire for connecting a positive electrode and a conductor of a lead wire for connecting a negative electrode, and an insulating layer which does not melt at a heat sealing temperature of a sealing bag is provided for insulation of the lead wire has been proposed as a conventional technique (refer to Patent Literature 1).

### CITATION LIST

### Patent Literature

Patent literature 1: Japanese Unexamined Patent Application Publication No. H9-265974

### SUMMARY OF INVENTION

A nonaqueous electrolyte solution battery lead wire according to the present disclosure includes a conductor, and an insulating film having one or a plurality of layers and covering at least part of an outer peripheral surface of the conductor. The conductor has a conductor film covering at least part of a surface thereof, the conductor film contains a trivalent chromium compound including chromium hydroxide and a metal element, a ratio of a mass of chromium contained in the chromium hydroxide per unit area [mg/m²] to a mass of chromium contained in the trivalent chromium compound per unit area [mg/m²] is 0.30 to 0.90 at an outermost surface of the conductor film, the insulating film has an innermost layer stacked on a surface of the conductor film, the innermost layer contains, as a main component, a resin component including maleic anhydride-modified polypropylene, and an acid modification ratio of the resin component is 0.02% by mass to 0.50% by mass.

### BRIEF DESCRIPTION OF THE DRAWINGS

FIG. 1 is a perspective view of a nonaqueous electrolyte solution battery lead wire according to an embodiment of the present disclosure.

FIG. 2 is a fragmentary sectional view of a nonaqueous electrolyte solution battery lead wire according to an embodiment of the present disclosure.

FIG. 3 is a perspective view showing an example of a nonaqueous electrolyte solution battery including a nonaqueous electrolyte solution battery lead wire according to an embodiment of the present disclosure.

FIG. 4 is a longitudinal sectional view of the nonaqueous electrolyte solution battery of FIG. 3.

### DETAILED DESCRIPTION

### Problems to be Solved by Present Disclosure

Although the adhesive of such tab leads are sufficient immediately after sealing the opening of the enclosing container, over long-term use, moisture is more likely to permeate the seal portion. The permeated water reacts with the nonaqueous electrolyte solution enclosed inside the enclosing container, thereby generating hydrofluoric acid. Hydrofluoric acid is likely to corrode a metal lead conductor, and the corrosion of the metal lead conductor may cause peeling at the interface between the conductor and the insulating film. Thus, the tab lead is required to have improved tolerance to the nonaqueous electrolyte solution.

An object of the present disclosure is to provide a nonaqueous electrolyte solution battery lead wire having excellent tolerance to a nonaqueous electrolyte solution of a nonaqueous electrolyte solution battery.

### Advantageous Effects of Present Disclosure

According to the present disclosure, a nonaqueous electrolyte solution battery lead wire having excellent tolerance to a nonaqueous electrolyte solution of a nonaqueous electrolyte solution battery can be provided.

### Description of Embodiments of Present Disclosure

First, embodiments of the present disclosure will be listed and described.

A nonaqueous electrolyte solution battery lead wire according to the present disclosure includes a conductor, and an insulating film having one or a plurality of layers and covering at least part of an outer peripheral surface of the conductor. The conductor has a conductor film covering at least part of a surface thereof, the conductor film contains a trivalent chromium compound including chromium hydroxide and a metal element, a ratio of a mass of chromium contained in the chromium hydroxide per unit area [mg/m²] to a mass of chromium contained in the trivalent chromium compound per unit area [mg/m²] is 0.30 to 0.90 at an outermost surface of the conductor film, the insulating film has an innermost layer stacked on a surface of the conductor film, the innermost layer contains, as a main component, a resin component including maleic anhydride-modified polypropylene, and an acid modification ratio of the resin component is 0.02% by mass to 0.50% by mass.

In the nonaqueous electrolyte solution battery lead wire, the conductor is covered with the conductor film that contains a trivalent chromium compound including chromium hydroxide and a metal element, and thus it is possible to reduce peeling at the interface between the conductor and the insulating film, which is caused by corrosion of the conductor due to hydrofluoric acid generated by hydrolysis of the nonaqueous electrolyte solution. Further, the innermost layer stacked on the surface of the conductor film contains, as a main component, a resin component including maleic anhydride-modified polypropylene, and the acid modification ratio of the resin component is 0.02% by mass to 0.50% by mass, and thus the adhesive between the innermost layer and the conductor film is good. Furthermore, the ratio of the mass of the chromium atoms per unit area [mg/m²] of the chromium hydroxide to the mass of the chromium atoms per unit area [mg/m²] of the trivalent chromium compound in the outermost surface of the conductor film is 0.30 to 0.90, whereby the conductor film has a sufficient amount of hydrogen-bonding with the maleic anhydride-modified polypropylene in the innermost layer, and the mechanical strength of the conductor film is improved, so that the adhesive strength between the conductor and the insulating film can be improved. Since the ratio of the mass of the chromium atoms per unit area of the chromium hydroxide to the mass of the chromium atoms per unit area of the trivalent chromium compound is 0.30 to 0.90, the outermost surface of the conductor film has a smaller amount of hydroxyl groups on the surface than an untreated conductor surface which is considered to be covered with almost 100% hydroxide due to adhesion of moisture from the air. In contrast, by setting the acid modification ratio of the resin component, which is the main component of the innermost layer, to 0.02% by mass to 0.50% by mass, the hydroxyl groups on the conductor surface can be compensated for, and thus, the adhesive strength between the conductor and the insulating film can be further improved. Thus, the nonaqueous electrolyte solution battery lead wire has excellent tolerance to the nonaqueous electrolyte solution of the nonaqueous electrolyte solution battery.

The ratio of the mass of the chromium atoms per unit area [mg/m²] of the chromium hydroxide to the trivalent chromium compound can be determined from the mass of the chromium atoms per unit area on the outermost surface of the conductor film and the mass of the hydroxyl groups per unit area on the outermost surface of the conductor film. The mass of chromium atoms per unit area at the outermost surface of the conductor film is calculated using X-ray photoelectron spectroscopy (hereinafter, also referred to as “XPS”). The term “in the outermost surface of the conductor film” means a region to a detection depth measurable by the X-ray photoelectron spectrometry with respect to an arbitrary surface, and concretely means a region extending from the arbitrary surface to about 5 nm in the depth direction. In the present disclosure, the term “main component” means a component whose content exceeds 50% by mass.

The metal element is preferable to be nickel, aluminum, copper, or a combination thereof. When the conductor film includes nickel, aluminum, copper, or a combination thereof as a metal element, the conductivity of the conductor can be further improved.

The conductor film preferably further contains a calcium compound, a fluorine compound, or a combination thereof. By further containing calcium compounds in the conductor film, when using the nonaqueous electrolyte solution battery lead wire for nonaqueous electrolyte solution batteries in a nonaqueous electrolyte solution battery, the stability of the conductor film against decomposition products of nonaqueous electrolyte solutions in the nonaqueous electrolyte solution battery is improved, allowing for excellent corrosion resistance. By further containing fluorine compounds in the conductor film, the formation of a stable passivation film is promoted, thereby further improving corrosion resistance.

The acid modification ratio of the resin component is preferably 0.10% by mass to 0.50% by mass. When the acid modification ratio of the resin component is 0.10% by mass to 0.50% by mass, the adhesive strength between the conductor and the insulating film can be further improved.

The conductor film is preferable to have an average thickness of 1 nm to 50 nm. When the conductor film has an average thickness of 1 nm to 50 nm, the conductor has good corrosion resistance.

The insulating film is preferable to have an average thickness of 0.05 mm to 0.50 mm. When the insulating film has an average thickness of 0.05 mm to 0.50 mm, the gap between the insulating film and the enclosing container can be sufficiently filled, and the amount of moisture that permeates the insulating film from the air and enters the inside of the nonaqueous electrolyte solution battery can be reduced.

The innermost layer is preferable to have an average thickness of 0.01 mm to 0.25 mm. When the innermost layer has an average thickness of 0.01 mm to 0.25 mm, the adhesive to the conductor can be enhanced, and the amount of moisture that permeates the insulating film from the air and enters the inside of the nonaqueous electrolyte solution battery can be reduced.

The conductor is preferable to be nickel, nickel-plated metal, nickel-phosphorus alloy-plated metal, aluminum, or aluminum alloy. When the conductor is nickel, nickel-plated metal, nickel-phosphorus alloy-plated metal, aluminum, or aluminum alloy, the conductivity, the potential resistance, and the like can be improved.

Further, a nonaqueous electrolyte solution battery according to the present disclosure includes an enclosing container, a plurality of the nonaqueous electrolyte solution battery lead wires disposed so as to extend from an inside to an outside of the enclosing container, and a nonaqueous electrolyte solution.

The nonaqueous electrolyte solution battery includes a plurality of the nonaqueous electrolyte solution battery lead wires, and thus can reduce peeling between the conductor and the insulating film and improve the sealing property.

### Details of Embodiments of Present Disclosure

Hereinafter, a nonaqueous electrolyte solution battery lead wire and a nonaqueous electrolyte solution battery according to the present disclosure will be described in detail.

### <Nonaqueous Electrolyte Solution Battery Lead Wire>

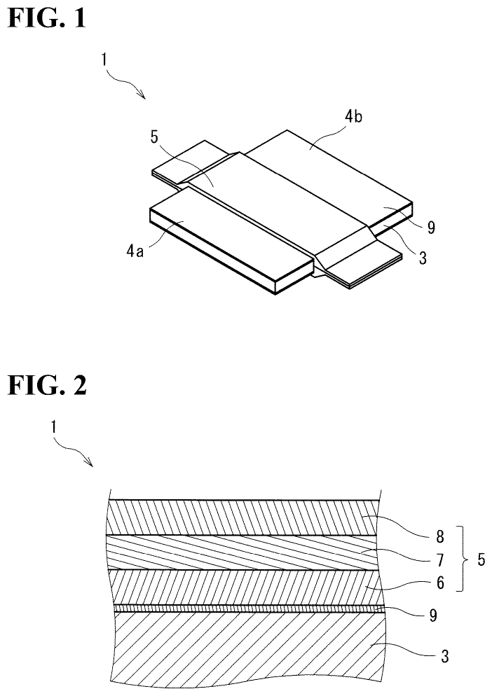

FIG. 1 is a perspective view of a nonaqueous electrolyte solution battery lead wire according to an embodiment of the present disclosure. FIG. 2 is a fragmentary sectional view of a nonaqueous electrolyte solution battery lead wire according to an embodiment of the present disclosure. As shown in FIG. 1 and FIG. 2, a nonaqueous electrolyte solution battery lead wire 1 includes a conductor 3 and an insulating film 5 having one or more layers and covering at least part of the outer peripheral surface of conductor 3. Conductor 3 having one end 4a and other end 4b has a conductor film 9 covering at least part of the surface. In the embodiment, insulating film 5 includes an innermost layer 6 stacked on the surface of conductor 3, a first insulating layer 8 stacked on the outermost surface of insulating film 5, and a second insulating layer 7 stacked on the inner surface of first insulating layer 8. It is noted that, the conductor corresponds to a lead conductor.

### (Conductor)

Conductor 3 is connected to an electrode or the like of the nonaqueous electrolyte solution battery. From the viewpoint of conductivity, examples of the material of conductor 3 include metal materials such as aluminum, titanium, nickel, copper, aluminum alloy, titanium alloy, nickel alloy, and copper alloy, nickel-plated metal obtained by plating these metal materials with nickel, and nickel-phosphorus alloy-plated metal. Among these, nickel, nickel-plated metal, and nickel-phosphorus alloy-plated metal are preferable as the material for forming conductor 3 connected to the negative electrode of the nonaqueous electrolyte solution battery. As the material for forming conductor 3 connected to the positive electrode, aluminum and aluminum alloy are preferable from the viewpoint of potential resistance, high conductivity, and cost.

The lower limit of the average thickness of conductor 3 is preferably 0.10 mm. When the average thickness of conductor 3 is 0.10 mm or more, a sufficient amount of current can be passed in practical use as a battery. The lower limit of the average thickness of conductor 3 may be 0.15 mm or 0.20 mm. The upper limit of the average thickness of conductor 3 is not particularly limited, and can be appropriately set according to, for example, the capacity of the nonaqueous electrolyte solution battery. For example, the upper limit of the average thickness is preferably 5.00 mm. When the average thickness of conductor 3 is 5.00 mm or less, the resistance heating at the lead portion can be reduced even when rapidly charging and discharging are performed with the lead. Further, the upper limit of the average thickness of conductor 3 may be further increased to 4 mm. It is noted that, the “average thickness” of conductor 3 is an average value of the measured values of the thickness at 10 points. Hereinafter, the “average thickness” has the same meaning.

### (Conductor Film)

Conductor film 9 covers at least part of the surface of conductor 3. Conductor film 9 contains a trivalent chromium compound including chromium hydroxide and a metal element. Conductor 3 is covered with the conductor film contains a trivalent chromium compound including chromium hydroxide and a metal element, and thus conductor 3 has good corrosion resistance.

The metal element is preferable to be nickel, aluminum, copper, or a combination thereof. Conductor film 9 includes nickel, aluminum, copper, or a combination thereof as a metal element, and thus the conductivity of conductor 3 can be further improved.

The lower limit of a ratio of a mass of chromium contained in the chromium hydroxide per unit area [mg/m²] to a mass of chromium contained in the trivalent chromium compound per unit area [mg/m²] on the outermost surface of conductor film 9 is 0.30, and preferably 0.40. When the mass ratio is less than 0.30, conductor film 9 cannot form a sufficient amount of hydrogen bonds with the maleic anhydride-modified polypropylene in innermost layer 6, and the adhesive strength between the conductor and the insulating film may be insufficient. The upper limit of the mass ratio of the chromium atoms per unit area of the chromium hydroxide to the trivalent chromium compound is 0.90, and preferably 0.80. When the mass ratio exceeds 0.90, the mechanical strength of conductor film 9 is reduced, and the adhesive strength between conductor 3 and insulating film 5 may be insufficient.

Conductor film 9 preferably further contains a calcium compound, a fluorine compound, or a combination thereof. By further containing calcium compounds in conductor film 9, when using nonaqueous electrolyte solution battery lead wire 1 for nonaqueous electrolyte solution batteries in a nonaqueous electrolyte solution battery, the stability of conductor film 9 against decomposition products of nonaqueous electrolyte solutions in the nonaqueous electrolyte solution battery is improved, allowing for excellent corrosion resistance. By further containing fluorine compounds in conductor film 9, the formation of a stable passivation film is promoted, thereby further improving corrosion resistance. Examples of the calcium compound include calcium oxide, calcium hydroxide, calcium carbonate, calcium chromate, calcium chromate dihydrate, anhydrous calcium chromate, and calcium aluminate compounds. Examples of the fluorine compound include calcium fluoride, chromium fluoride, aluminum fluoride, and copper fluoride. The calcium compound and the fluorine compound in conductor film 9 can be checked by XPS.

The lower limit of the average thickness of conductor film 9 is preferably 1 nm, and more preferably 3 nm. When the average thickness of conductor film 9 is 1 nm or more, conductor 3 can be sufficient corrosion resistance. The upper limit of the average thickness of conductor film 9 is preferably 50 nm, and more preferably 20 nm. Conductor film 9 having an average thickness of 50 nm or less can suppress a decrease in the density of conductor film 9 due to the formation of cracks, and can maintain a good corrosion resistance. The average thickness of conductor film 9 can be measured by analyzing the elements present on the surface of conductor 3 covered with conductor film 9 using XPS.

### (Insulating Film)

Insulating film 5 is used as an insulating film of nonaqueous electrolyte solution battery lead wire 1. Insulating film 5 includes one or more insulating layers, and is stacked on the outer peripheral surface of conductor 3 so as to cover at least part of the outer peripheral surface of conductor 3. Insulating film 5 has one or more insulating layers 3, and thus various functions can be imparted according to the purpose of nonaqueous electrolyte solution battery lead wire 1. Nonaqueous electrolyte solution battery lead wire 1 of the embodiment includes insulating film 5 having three insulating layers 3.

The lower limit of the average thickness of insulating film 5 is preferably 0.05 mm. When the average thickness of insulating film 5 is 0.05 mm or more, the gap between insulating film 5 and an enclosing container 11, which is formed by the step corresponding to the height of conductor 3, can be reliably sealed by filling the gap with insulating film 5. Further, the lower limit of the average thickness of insulating film 5 may be 0.08 mm or 0.10 m. The upper limit of the average film thickness of insulating film 5 is preferably 0.50 mm. When the average thickness of insulating film 5 is 0.50 mm or less, it is possible to reduce the amount of moisture infiltrating into the inside of a nonaqueous electrolyte solution battery 10 through insulating film 5 from the air, thereby reducing the degradation of the nonaqueous electrolyte solution battery. Further the upper limit of the average thickness of insulating film 5 may be 0.40 mm or 0.30 mm. In the present disclosure, the average thickness of insulating film 5 is an average value of the measured values of the thickness at 10 points on the surface having the largest area among the outer peripheral surface of insulating film 5.

In the embodiment, insulating film 5 includes innermost layer 6 stacked on the surface of conductor 3, first insulating layer 8 stacked on the outermost surface of insulating film 5, and second insulating layer 7 stacked on the inner surface of first insulating layer 8.

### (Innermost Layer)

Innermost layer 6 is stacked on the surface of conductor film 9. Insulating film 5 can reduce corrosion of conductor 3 by having innermost layer 6.

Innermost layer 6 contains a resin component containing maleic anhydride-modified polypropylene (maleic anhydride-modified PP) as a main component. Innermost layer 6 contains, as a main component, a resin component including maleic anhydride-modified polypropylene, and thus has good adhesive to conductor film 9.

The lower limit of the acid modification ratio of the resin component is 0.02% by mass, and preferably 0.10% by mass. When the acid modification ratio of the resin component is 0.02% by mass or more, the adhesive between innermost layer 6 and conductor film 9 is enhanced, and sufficient tolerance to the nonaqueous electrolyte solution can be obtained. The upper limit of the acid modification ratio of the resin component is 0.50% by mass, and preferably 0.40% by mass. When the acid modification ratio of the resin component is 0.50% by mass or less, the maleic anhydride modification group reduces corrosion of conductor 3, and thus the corrosion resistance can be improved. The acid modification ratio is calculated by converting the mass of the carboxyl group measured from the peak area at 1710 cm⁻¹ by infrared spectroscopic transmission method (transmission FT-IR) from the average thicknesses of the six innermost layers based on an appropriate calibration curve.

The melting point of the maleic anhydride-modified polypropylene is preferably 130° C. to 170° C., and more preferably 130° C. to 150° C. When the melting point of the maleic anhydride-modified polypropylene is lower than 130° C., the heat resistance may be reduced. When the melting point of the maleic anhydride-modified polypropylene exceeds 170° C., the amount of heat required to melt the maleic anhydride-modified polypropylene is large, and thus the maleic anhydride-modified polypropylene is not sufficiently melted, and thus innermost layer 6 may not have sufficient adhesive to conductor 3.

The lower limit of the content of the maleic anhydride-modified polypropylene in innermost layer 6 is preferably 0.1% by mass, and more preferably 0.5% by mass. When the content of the maleic anhydride-modified polypropylene is less than 0.1% by mass, practically sufficient material properties may not be obtained.

In innermost layer 6, the resin component may contain a thermoplastic resin other than the maleic anhydride-modified polypropylene within a range not inhibiting the effect of the present disclosure. Examples of the thermoplastic resin other than the maleic anhydride-modified polypropylene include polyolefins such as polypropylene and polyethylene. Further, innermost layer 6 may contain other known additives. Examples of the known additives include antioxidants, flame retardants, tackifiers, lubricants, fillers, crystallization accelerators, and colorants.

The lower limit of the average thickness of innermost layer 6 is preferably 0.01 mm. When the average thickness of innermost layer 6 is larger than 0.01 mm, sufficient adhesive to conductor 3 can be achieved. Further, the lower limit of the average thickness of innermost layer 6 may be 0.02 mm or 0.03 mm. The upper limit of the average thicknesses of innermost layer 6 is preferably 0.25 mm. When the average thickness of innermost layer 6 is 0.25 mm or less, it is possible to reduce the amount of moisture entering inside of the nonaqueous electrolyte solution battery through insulating film 5 from the air, thus reducing battery degradation. Further, the upper limit of the average thickness of innermost layer 6 may be 0.22 mm or 0.20 mm. In the present disclosure, the average thickness of innermost layer 6 is an average value of the measured values of the thickness at 10 points on the surface having the largest area in the outer peripheral surface of innermost layer 6.

### (First Insulating Layer)

First insulating layer 8 is disposed farthest from conductor 3 and is formed of a thermoplastic resin. First insulating layer 8 is stacked on the outermost surface of insulating film 5 and stacked on the surface of second insulating layer 7. First insulating layer 8 preferably contains, as a main component, a resin that is easily melted at a heat sealing temperature when the opening of the enclosing container is heat-sealed, and more preferably contains, as a main component, polyolefin.

Examples of the polyolefin include polypropylene, polyethylene, and derivatives thereof. More specifically, combinations of homopolypropylene, block polypropylene, random polypropylene, low crystalline polypropylene, low density polyethylene, linear low density polyethylene, low crystalline ethylene-propylene copolymer, low crystalline ethylene-butylene copolymer, low crystalline ethylene-octene copolymer, low crystalline propylene-ethylene copolymer, and the like are mentioned. First insulating layer 8 may contain a plurality of resins. Polypropylene is preferable as the polyolefin, and random polypropylene having a melting temperature of 120° C. to 155° C. and an MFR of 3 g/10 minutes to 15 g/10 minutes is more preferable as the polypropylene. When the polyolefin is random polypropylene, there is an advantage that the adhesive between second insulating layer 7 and the innermost resin layer of the enclosing container can be sufficiently exhibited.

The lower limit of the content of polyolefin in first insulating layer 8 is preferably 70% by mass. When the content of polyolefin is less than 70% by mass, practically sufficient material characteristics may not be obtained. Further, the lower limit of the content of polyolefin in first insulating layer 8 may be 80% by mass, 90% by mass, or 100% by mass.

First insulating layer 8 may contain a thermoplastic resin other than the above polyolefin within a range not inhibiting the effect of the present disclosure.

First insulating layer 8 may contain other known additives within a range not inhibiting the effect of the present disclosure. Examples of the known additives include antioxidants, flame retardants, tackifiers, lubricants, fillers, crystallization accelerators, and colorants.

The lower limit of the average thickness of first insulating layer 8 is preferably 25 μm. When the average thickness of first insulating layer 8 is less than 25 μm, the strength of first insulating layer 8 may not be sufficiently obtained. Further, the lower limit of the average thickness of first insulating layer 8 may be 30 μm or 40 μm. The upper limit of the average thickness of first insulating layer 8 is preferably 250 μm. When the average thickness of first insulating layer 8 exceeds 250 μm, the amount of moisture that permeates insulating film 5 from the air and enters the inside of the nonaqueous electrolyte solution battery increases, and may accelerate battery degradation. Here, in the present disclosure, the average thickness of first insulating layer 8 is an average value of the measured values of the thickness at 10 points on the surface having the largest area in the outer peripheral surface of first insulating layer 8.

### (Second Insulating Layer)

Insulating film 5 may have second insulating layer 7 between first insulating layer 8 and innermost layer 6. Second insulating layer 7 is stacked on the inner surface of first insulating layer 8. Second insulating layer 7 preferably contains a cross-linked polyolefin or polyolefin having a higher melting point than innermost layer 6. By containing a cross-linked polyolefin or a polyolefin resin with a higher melting point than innermost layer 6, second insulating layer 7 is less likely to melt at the heat sealing temperature when heat sealing the opening of the enclosing container, enabling to reduce short-circuiting between the metal layer of the enclosing container and the conductor.

Examples of the polyolefin in the cross-linked polyolefin include polypropylene, polyethylene, and derivatives thereof.

As the polyolefin having a high melting point, polypropylene having a melting point of 155° C. or higher is preferable, and homopolypropylene, block polypropylene, thermoplastic olefin elastomer (TPO), and the like are particularly preferable.

Second insulating layer 7 may contain a thermoplastic resin other than the cross-linked polyolefin, and may contain other known additives, within a range not inhibiting the effect of the present disclosure. Examples of the known additives include antioxidants, flame retardants, tackifiers, lubricants, fillers, crystallization accelerators, and colorants.

The lower limit of the average thickness of second insulating layer 7 is preferably 25 μm. When the average thickness of second insulating layer 7 is less than 25 μm, the strength of second insulating layer 7 may not be sufficiently obtained. Further, the lower limit of the average thickness of second insulating layer 7 may be 30 μm or 40 μm. The upper limit of the average thickness of second insulating layer 7 is preferably 250 μm. When the average thickness of second insulating layer 7 exceeds 250 μm, the amount of moisture that permeates insulating film 5 from the air and enters the inside of the nonaqueous electrolyte solution battery may be likely to increase. In the present disclosure, the average thickness of second insulating layer 7 is an average value of measured values of the thickness at 10 points on a surface having the largest area in the outer peripheral surface of second insulating layer 7.

[Manufacturing method of Nonaqueous Electrolyte Solution Battery Lead Wire]

The manufacturing method of the nonaqueous electrolyte solution battery lead wire is not particularly limited, and the nonaqueous electrolyte solution battery lead wire can be produced by a known method.

First, at least part of the surface of the conductor is subjected to a chemical conversion treatment (chromate treatment) by the following method using a treatment solution, and is coated with a conductor film. First, for example, the degreasing treatment are performed on the front and rear surfaces and the side surfaces of the conductor. During the molding, conductors may sometimes have oily components adhere to their surface, and the degreasing is conducted to remove these oily components or oils. The degreasing treatment can be performed by coating or immersing the aluminum plate with an organic solvent, a surfactant, an acid, or an alkaline solution. Next, after the organic solvent, the surfactant, the acid, and the alkaline solution are cleaned and removed, and the metal surface is dried, the metal surface is subjected to a chemical conversion treatment using a solution containing a chromate as a main component.

Examples of the acidic compound substance used for degreasing include inorganic acids such as hydrochloric acid, sulfuric acid, nitric acid, hydrofluoric acid, phosphoric acid, and sulfamic acid, citric acid, gluconic acid, oxalic acid, tartaric acid, formic acid, hydroxyacetic acid, EDTA (ethylene diamine tetra acetic acid), and ammonium thioglycolate. Examples of alkaline compounds include sodium salts such as sodium hydroxide (NaOH), sodium carbonate (Na₂CO₃), baking soda (NaHCO₃), sodium sulfate decahydrate (Na₂SO₄ 10H₂O), and sodium sesquicarbonate (Na₂CO₃ NaHCO₃ 2H₂O), silicates like sodium orthosilicate (2Na₂O·SiO₂, water content 10%-40%), and sodium metasilicate (2Na₂O·SiO₂·9H₂O), and phosphate salts such as sodium dihydrogen phosphate (NaH₂PO₄), sodium pyrophosphate (Na₄P₂O₇), disodium hydrogen phosphate (Na₂HPO₄), sodium hexametaphosphate ((NaPO₃)₆), and trisodium phosphate (Na₃PO₄).

As a method of chemical conversion treatment, a treatment solution is applied and dried on the conductor to chemically convert the front and back surfaces, as well as the side surfaces or the like, of the conductor by a method such as coating the conductor with a treatment liquid using a method of immersing conductor in treatment liquid, a method of spraying treatment liquid on the conductor, or roll coating method. In the chemical conversion treatment, at least the portion covered with the insulating film may be treated, but it is desirable to treat the entire circumference of the conductor by using a dipping method, a shower method, a roll-coating method, or the like.

As the treatment solution for the chemical conversion treatment, an aqueous solution containing 5.0 g/L of chromium chloride hexahydrate and 170 g/L of potassium formate is used. The conductor is coated with the treatment solution by cathodic electrolysis method for 30 seconds at 45° C. and a current density of 10 A/dm². Next, after drying, the conductor film is formed by baking under the condition of a heating temperature of 100° C. to 300° C.

Next, an insulating film covers at least part of the outer peripheral surface of the conductor coated with the conductor film. The manufacturing method of the insulating film is not particularly limited. For example, the resin components of the respective insulating layers and the resin composition for forming containing the additives are mixed using a known mixing apparatus such as an open roll, a pressure kneader, a single-screw mixer, or a double-screw mixer. Next, when each insulating layer is produced, each film-like insulating layer can be produced by extrusion molding such as T-die molding or inflation molding. Then, the respective insulating layers are superposed and bonded by heat lamination using a heating roll. Further, a plurality of insulating layers can be formed simultaneously by using an inflation method or a T-die method by co-extrusion. Furthermore, an extrusion lamination method in which a molten resin is stacked on a film formed as a single layer can be used. The film-like insulating film is cut into a predetermined size and is bonded to both surfaces of the conductor by heating and pressing by a thermocompression bonding method, thereby covering at least part of the outer peripheral surface of the conductor. The insulating layer can be produced not only by extrusion molding but also by injection molding. In the injection molding, the circumferential surface of the conductor can be covered by injecting a resin after the conductor is mounted in a mold, and two color molding can be used when a plurality of layers are formed.

The nonaqueous electrolyte solution battery lead wire has excellent tolerance to a nonaqueous electrolyte solution of a nonaqueous electrolyte solution battery.

### <Nonaqueous Electrolyte Solution Battery>

Nonaqueous electrolyte solution battery 10 includes nonaqueous electrolyte solution battery lead wire 1 described above and a nonaqueous electrolyte solution. Examples of the nonaqueous electrolyte solution battery include secondary batteries such as lithium ion batteries.

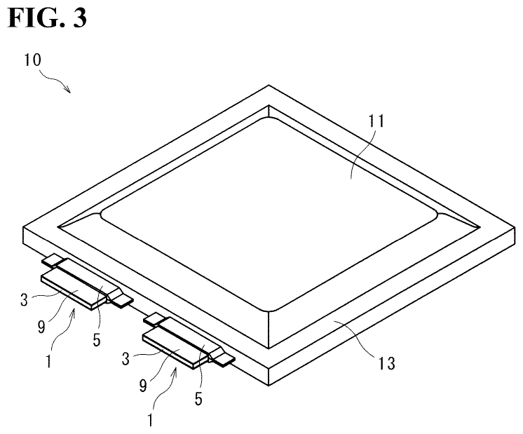

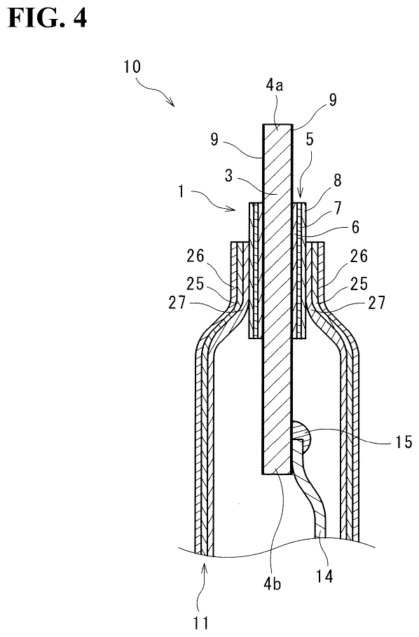

FIG. 3 is a perspective view showing an example of a nonaqueous electrolyte solution battery including the nonaqueous electrolyte solution battery lead wire. FIG. 4 is a fragmentary sectional view schematically showing an embodiment of a nonaqueous electrolyte solution battery. Nonaqueous electrolyte solution battery (nonaqueous electrolyte solution secondary battery) 10 shown in FIG. 3 and FIG. 4 includes a plate-shaped positive electrode, a plate-shaped negative electrode, and a nonaqueous electrolyte solution (not shown), enclosing container 11, and a plurality of, specifically, two nonaqueous electrolyte solution battery lead wires 1. Nonaqueous electrolyte solution battery lead wire 1 is the nonaqueous electrolyte solution battery lead wire described above. In nonaqueous electrolyte solution battery lead wire 1 of the embodiment, as described above, insulating film 5 includes innermost layer 6, second insulating layer 7, and first insulating layer 8. Nonaqueous electrolyte solution battery 10 includes a substantially rectangular enclosing container 11 and two nonaqueous electrolyte solution battery lead wires 1 extending from the inside to the outside of enclosing container 11. Conductor 3 and enclosing container 11 are connected to each other at a seal portion 13 of enclosing container 11 through insulating film 5. Enclosing container 11 is a container that houses the positive electrode, the negative electrode, the separator, and the nonaqueous electrolyte solution in a sealed state.

The positive electrode and negative electrode (not shown) are stacked through a separator, forming a stacked electrode group. The stacked electrode group and a nonaqueous electrolyte solution are hermetically accommodated in enclosing container 11. In enclosing container 11, the stacked electrode group is immersed in the electrolyte solution. Enclosing container 11 is formed from a sheet body as described later. In enclosing container 11, seal portion 13 around the two sheet bodies or the folded one sheet body is heat-sealed so that container 11 is in a sealed state.

As shown in FIG. 4, in two nonaqueous electrolyte solution battery lead wires 1, one of nonaqueous electrolyte solution battery lead wires 1 is disposed such that one end 4a of conductor 3 is exposed from enclosing container 11 and other end 4b is connected to the positive electrode in enclosing container 11. The other nonaqueous electrolyte solution battery lead wire 1 is disposed such that one end 4a of conductor 3 is exposed from enclosing container 11 and other end 4b is connected to the negative electrode in enclosing container 11.

Enclosing container 11 is not stacked on both end portions of conductor 3, that is, one end 4a and other end 4b. One end 4a of conductor 3 is exposed from enclosing container 11. Other end 4b of conductor 3 of nonaqueous electrolyte solution battery lead wire 1 on the positive electrode side is connected to an internal connection lead wire 14 through a solder portion 15, and is connected to a positive electrode (not shown) by internal connection lead wire 14. Similarly, other end 4b of conductor 3 of nonaqueous electrolyte solution battery lead wire 1 on the negative electrode side is connected to internal connection lead wire 14 through solder portion 15, and is connected to the negative electrode (not shown) by internal connection lead wire 14. As shown in FIG. 4, the middle portion of nonaqueous electrolyte solution battery lead wire 1 is sandwiched between sheet bodies as enclosing container 11 through insulating film 5, and in this portion, enclosing container 11 and first insulating layer 8 of the plurality of nonaqueous electrolyte solution battery lead wires 1 are heat-sealed.

The positive electrode and the negative electrode are typically a stacked body in which an active material layer containing an active material is stacked over a surface of a current collector such as a metal foil. The positive electrode and the negative electrode are usually plate shaped, but may have a shape other than a plate shape.

The separator is usually an insulating and porous film. The separator is impregnated with a nonaqueous electrolyte solution.

The nonaqueous electrolyte solution includes a nonaqueous solvent and an electrolytic salt dissolved in the nonaqueous solvent.

As shown in FIG. 4, enclosing container 11 is composed of a sheet body in which an innermost resin layer 27, a metal layer 25, and an outermost resin layer 26 are stacked in this order. Enclosing container 11 is formed by overlapping two sheet bodies and heat-sealing three sides other than the side which the conductor permeates to form seal portion 13. Further, in seal portion 13, conductor 3 of each nonaqueous electrolyte solution battery lead wire 1 is bonded to enclosing container 11 with insulating film 5 interposed therebetween. In this portion, innermost resin layer 27 of enclosing container 11 and first insulating layer 8 of each nonaqueous electrolyte solution battery lead wire 1 are heat-sealed.

Innermost resin layer 27 is directly stacked on the inner surface of metal layer 25. It is preferable to use an insulating resin which is not dissolved in the nonaqueous electrolyte solution and is melted by heating for innermost resin layer 27 positioned inside enclosing container 11. As innermost resin layer 27, for example, polyolefin, acid-modified polyolefin, acid-modified styrene elastomer, or the like can be used. Among these, polypropylene is preferable as innermost resin layer 27. The range of the average thickness of innermost resin layer 27 is preferably about 10 μm to 500 μm.

Metal layer 25 has functions of improving the strength of enclosing container 11, preventing water vapor, oxygen, light, and the like from entering the inside of the battery, and the like. Metal layer 25 is formed of a metal such as an aluminum foil. Metal layer 25 has a metal as a main component. As for this metal, aluminum, copper, stainless steel, and titanium can be examples, and aluminum is particularly preferable. Metal layer 25 is substantially formed of metal, but may contain an additive or the like other than metal. Metal layer 25 is in the form of a film, and is preferably formed of a metal foil, and more preferably formed of an aluminum alloy foil. The average thickness of metal layer 25 is preferably about 10 μm to 50 μm.

Outermost resin layer 26 has a function of protecting the outer surface of metal layer 25, a function of providing insulation, and the like. Outermost resin layer 26 positioned outside the enclosing container is made of an insulating material, and usually contains a resin as a main component. Examples of the resin forming outermost resin layer 26 include polyethylene terephthalate (PET), polyamide, polyester, polyolefin, epoxy resin, acrylic resin, fluororesin, polyurethane, silicon resin, phenol resin, polyetherimide, polyimide, and mixtures and copolymers thereof. Outermost resin layer 26 may be composed of a plurality of layers through an adhesive layer containing, for example, polyethylene terephthalate or polyamide interposed therebetween. Further, the average thickness of outermost resin layer 26 is preferably in the range of about 10 μm to 50 μm.

In nonaqueous electrolyte solution battery 10, as described above, one end of nonaqueous electrolyte solution battery lead wire 1, that is, one end 4a of conductor 3 is disposed in a state of being exposed from enclosing container 11, and is sealed by enclosing container 11. Specifically, nonaqueous electrolyte solution battery lead wire 1 is disposed such that the innermost resin layer of enclosing container 11 and insulating film 5 of nonaqueous electrolyte solution battery lead wire 1 are in direct contact with each other. Further, in a state in which nonaqueous electrolyte solution battery lead wire 1 is disposed as described above, innermost resin layer 27 in seal portion 13 of enclosing container 11 and first insulating layer 8 of nonaqueous electrolyte solution battery lead wire 1 are heat-sealed. Accordingly, the positive electrode, the negative electrode, and the separator, which are the stacked electrode group immersed in the nonaqueous electrolyte solution, may be sealed in enclosing container 11.

### [Manufacturing Method of Nonaqueous Electrolyte Solution Battery]

A manufacturing method of the nonaqueous electrolyte solution battery according to an embodiment of the present disclosure may be appropriately selected from known methods. The manufacturing method of a nonaqueous electrolyte solution battery includes, for example, a step of preparing the nonaqueous electrolyte solution battery lead wire, a step of preparing a stacked electrode group, a step of preparing a nonaqueous electrolyte solution, and a step of housing the stacked electrode group to which the nonaqueous electrolyte solution battery lead wire is connected and the nonaqueous electrolyte solution in an enclosing container.

The nonaqueous electrolyte solution battery includes a plurality of the nonaqueous electrolyte solution battery lead wires, and thus can reduce peeling between the conductor and the insulating film and improve the sealing property.

### OTHER EMBODIMENTS

The embodiments disclosed herein are to be considered in all respects as illustrative and not restrictive. The scope of the present disclosure is not limited to the configurations of the above-described embodiments, but is indicated by the scope of the claims, and is intended to include all modifications within the scope and meaning equivalent to the scope of the claims.

In the above embodiment, the nonaqueous electrolyte solution battery lead wire includes the insulating film having a three layer structure including the innermost layer, the second insulating layer, and the first insulating layer. However, the nonaqueous electrolyte solution battery lead wire may include an insulating film having a two-layer structure not including the second insulating layer. The nonaqueous electrolyte solution battery lead wire may include an insulating film having a multilayer structure including one or more intermediate layers inside the second insulating layer.

### EXAMPLE

The present invention will be described in more detail with reference to the following examples, but the present invention is not limited to the following examples.

### [Test No. 1]

### (Production of Lead Conductor)

As a substrate of the lead conductor, an oxygen-free copper plate (C1020) having a length of 100 mm, a width of 45 mm, and an average thickness of 0.2 mm was used. As a pre-treatment, the substrate was immersed in an aqueous sodium hydroxide (40 g/L) at 25° C., and cathodic electrolytic degreasing was performed at a current density of 1.0 A/dm². The degreased substrate was cleaned with running water. Next, for the substrate after cleaning, the substrate was immersed in 10% by mass aqueous sulfuric acid at 25° C. for 30 seconds to perform acid activation. The substrate after the acid activation was cleaned with running water. Next, nickel amidosulfate tetrahydrate (350 g/L), nickel chloride hexahydrate (30 g/L), and boric acid (30 g/L) were mixed to obtain a nickel plating solution. The substrate after acid activation was immersed in a nickel plating solution at 50° C., and plating was performed at a current density of 5.0 A/dm² for 120 seconds. The substrate after plating was cleaned with running water, thereby obtaining a lead conductor made of nickel-plated copper (nickel-plated metal).

### (Formation of Conductor Film)

Chromium chloride hexahydrate (5.0 g/L) and potassium formate (170 g/L) were mixed with pure water to obtain a surface treatment solution. The lead conductor was immersed in the surface treatment solution at 45° C., and cathode electrolysis was performed for 30 seconds at a current density of 10 A/dm². The lead conductor after the cathode electrolysis was cleaned with running water and dried in a thermostatic bath at 100° C. for 180 seconds to obtain a lead conductor having a conductor film. The ratio of a mass of chromium contained in the chromium hydroxide per unit area [mg/m²] to a mass of chromium contained in the trivalent chromium compound per unit area [mg/m²] at the outermost surface of the conductor film was 0.40.

### (Production of Insulating Film)

A two-layer insulating film including an innermost layer and a first insulating layer was produced. First, the resin compositions of the innermost layer and the first insulating layer were produced by a mixing apparatus.

### (1) Innermost Layer

A resin component having an acid modification ratio of 0.01% by mass was obtained by kneading 100 parts by mass of “prime polypropylene F227D” (melting temperature: 142° C., MFR7) manufactured by Prime Polypropylene Co., Ltd. as random polypropylene (random PP) and 1 part by mass of “POLYBOND3000” (melting temperature: 157° C., acid modification ratio: 1.2% by mass) manufactured by SII group, Inc. as maleic anhydride-modified polypropylene with a biaxial kneader.

### (2) First Insulating Layer

As a material for the resin composition of the first insulating layer, random polypropylene “Prime polypropylene F227D” (MFR7 g/10 minutes, melting point 140° C.) manufactured by Prime Polymer Co., Ltd. was used.

### (3) Production of Insulating Film

Next, using a coat-hanger type two-kind-and-two-layer T-die film forming machine equipped with two single-screw extruders, the innermost layer resin composition was charged into the first extruder and the first insulating layer resin composition was charged into the second extruder, and the compositions were co-extruded to obtain a two-layer insulating film in which the innermost layer resin composition and the first insulating layer resin composition were stacked in this order. The average thickness of the innermost layer was 50 μm, and the average thickness of the first insulating layer was 100 μm.

### (Production of Nonaqueous Electrolyte Solution Battery Lead Wire)

Next, the obtained two layered insulating film was cut into a predetermined size, and heat sealing was performed on both surfaces of the conductor under the conditions of a mold temperature of 220° C. and a surface pressure of 0.2 MPa. Thus, a nonaqueous electrolyte solution battery lead wire No. 1 was obtained.

### [Test No. 2]

In the production of the insulating film, as a material of the resin composition of the innermost layer, nonaqueous electrolyte solution battery lead wire was obtained in the same manner as in Test No. 1, except using 100 parts by mass of “Prime polypropylene F227D” manufactured by Prime Polymer Co., Ltd. as random polypropylene and 5 parts by mass of “POLYBOND 3000” manufactured by SII group, Inc. as maleic anhydride-modified polypropylene, and obtaining the resin component with an acid modification ratio of 0.06% by mass.

### [Test No. 3]

In the production of the insulating film, as a material of the resin composition of the innermost layer, nonaqueous electrolyte solution battery lead wire was obtained in the same manner as in Test No. 1, except using 100 parts by mass of “Prime polypropylene F227D” manufactured by Prime Polymer Co., Ltd. as random polypropylene and 15 parts by mass of “POLYBOND 3000” manufactured by SII group, Inc. as maleic anhydride-modified polypropylene, and obtaining random PP with an acid modification ratio of 0.18% by mass.

### [Test No. 4]

In the production of the insulating film, as a material of the resin composition of the innermost layer, nonaqueous electrolyte solution battery lead wire was obtained in the same manner as in Test No. 1, except using 100 parts by mass of “Prime polypropylene F227D” manufactured by Prime Polymer Co., Ltd. as random polypropylene and 40 parts by mass of “POLYBOND 3000” manufactured by SII group, Inc. as maleic anhydride-modified polypropylene, and obtaining random PP with an acid modification ratio of 0.48% by mass.

### [Test No. 5]

In the production of the insulating film, as a material of the resin composition of the innermost layer, nonaqueous electrolyte solution battery lead wire was obtained in the same manner as in Test No. 1, except using 100 parts by mass of “Prime polypropylene F227D” manufactured by Prime Polymer Co., Ltd. as random polypropylene and 50 parts by mass of “POLYBOND 3000” manufactured by SII group, Inc. as maleic anhydride-modified polypropylene, and obtaining random PP with an acid modification ratio of 0.60% by mass.

### [Test No. 6]

In the formation of the conductor film, a nonaqueous electrolyte solution battery lead wire was obtained in the same manner as in No. 3, except obtaining the lead conductor having a conductor film in which the ratio of a mass of chromium contained in the chromium hydroxide per unit area to a mass of chromium contained in the trivalent chromium compound per unit area on the outermost surface of the conductor film was 0.80, by washing the lead conductor after the cathode electrolysis with running water and drying the lead conductor in a thermostatic bath at 100° C. for 30 seconds.

### [Test No. 7]

In the formation of the conductor film, a nonaqueous electrolyte solution battery lead wire was obtained in the same manner as in No. 3, except obtaining the lead conductor having a conductor film in which the ratio of a mass of chromium contained in the chromium hydroxide per unit area to a mass of chromium contained in the trivalent chromium compound per unit area on the outermost surface of the conductor film was 0.95, by washing the lead conductor after the cathode electrolysis with running water and drying the lead conductor in a thermostatic bath at 80° C. for 20 seconds.

### [Test No. 8]

In the formation of the conductor film, a nonaqueous electrolyte solution battery lead wire was obtained in the same manner as in No. 3, except obtaining the lead conductor having a conductor film in which the ratio of a mass of chromium contained in the chromium hydroxide per unit area to a mass of chromium contained in the trivalent chromium compound per unit area on the outermost surface of the conductor film was 0.20, by washing the lead conductor after the cathode electrolysis with running water and drying the lead conductor in a thermostatic bath at 250° C. for 3600 seconds.

### [Test No. 9]

A flat conductor made of an aluminum plate having a length of 100 mm, a width of 45 mm, and an average thickness of 0.4 mm was used as a substrate for the lead conductor. In the formation of the conductor film, chromium chloride hexahydrate (5.0 g/L) and potassium formate (170 g/L) were mixed with pure water to obtain a surface treatment solution. The lead conductor was immersed in the surface treatment solution at 45° C., and cathodic electrolysis was performed for 10 seconds at a current density of 10 A/dm². A nonaqueous electrolyte solution battery lead wire was obtained in the same manner as in No. 3, except obtaining the lead conductor having a conductor film in which the ratio of a mass of chromium contained in the chromium hydroxide per unit area to a mass of chromium contained in the trivalent chromium compound per unit area on the outermost surface of the conductor film was 0.60, by washing the lead conductor after the cathode electrolysis with running water.

### [Test No. 10]

A flat conductor made of an aluminum plate having a length of 100 mm, a width of 45 mm, and an average thickness of 0.4 mm was used as a substrate for the lead conductor. In the formation of the conductor film, chromium chloride hexahydrate (5.0 g/L), potassium formate (170 g/L), and potassium fluoride (5.0 g/L) were mixed with pure water to obtain a surface treatment solution. The lead conductor was immersed in the surface treatment solution at 45° C., and cathodic electrolysis was performed for 10 seconds at a current density of 10 A/dm². A nonaqueous electrolyte solution battery lead wire was obtained in the same manner as in No. 3, except obtaining the lead conductor having a conductor film in which the ratio of a mass of chromium contained in the chromium hydroxide per unit area to a mass of chromium contained in the trivalent chromium compound per unit area on the outermost surface of the conductor film was 0.40, by washing the lead conductor after the cathode electrolysis with running water.

### [Test No. 11]

In the formation of the conductor film, chromium chloride hexahydrate (5.0 g/L), potassium formate (170 g/L), and calcium chloride (0.5 g/L) were mixed with pure water to obtain a surface treatment solution. The lead conductor was immersed in the surface treatment solution at 45° C., and cathode electrolysis was performed for 30 seconds at a current density of 10 A/dm². A nonaqueous electrolyte solution battery lead wire was obtained in the same manner as in No. 2, except obtaining the lead conductor having a conductor film in which the ratio of a mass of chromium contained in the chromium hydroxide per unit area to a mass of chromium contained in the trivalent chromium compound per unit area on the outermost surface of the conductor film was 0.50, by washing the lead conductor after the cathode electrolysis with running water and drying the lead conductor in a thermostatic bath at 100° C. for 180 seconds.

### [Test No. 12]

In the formation of the conductor film, chromium chloride hexahydrate (5.0 g/L), potassium formate (170 g/L), and calcium chloride (5.0 g/L) were mixed with pure water to obtain a surface treatment solution. The lead conductor was immersed in the surface treatment solution at 45° C., and cathode electrolysis was performed for 30 seconds at a current density of 10 A/dm². A nonaqueous electrolyte solution battery lead wire was obtained in the same manner as in No. 2, except obtaining the lead conductor having a conductor film in which the ratio of a mass of chromium contained in the chromium hydroxide per unit area to a mass of chromium contained in the trivalent chromium compound per unit area on the outermost surface of the conductor film was 0.20, by washing the lead conductor after the cathode electrolysis with running water and drying the lead conductor in a thermostatic bath at 100° C. for 180 seconds.

### [Test No. 13]

As a substrate of the lead conductor, an oxygen-free copper plate (C1020) having a length of 100 mm, a width of 45 mm, and an average thickness of 0.2 mm was used. As a pre-treatment, the substrate was immersed in an aqueous sodium hydroxide (40 g/L) at 25° C., and cathodic electrolytic degreasing was performed at a current density of 1.0 A/dm². The degreased substrate was cleaned with running water. Next, for the substrate, after cleaning, the substrate was immersed in aqueous sulfuric acid (10% by mass) at 25° C. for 30 seconds to perform acid activation. The substrate after the acid activation was cleaned with running water. Next, a nonaqueous electrolyte solution battery lead wire was obtained in the same manner as in No. 3, except that the step of using the nickel plating solution was not performed.

### Evaluation

(The ratio of a mass of chromium contained in the chromium hydroxide per unit area to a mass of chromium contained in the trivalent chromium compound per unit area) The ratio of a mass of chromium contained in the chromium hydroxide per unit area to a mass of chromium contained in the trivalent chromium compound per unit area in the outermost surface of the conductor film can be measured by X-ray photoelectron spectroscopy (XPS). The measurement conditions of XPS are as follows. The ratio of a mass of chromium contained in the chromium hydroxide per unit area to a mass of chromium contained in the trivalent chromium compound per unit area was calculated by performing curve fitting of the spectrum obtained under the following measurement conditions and obtaining the ratio of the peak area.

### <Measurement Conditions of XPS>

X-ray source: AI-Kα
X-ray source power: 15 kV
Photoelectron take-off angle: 45°
Analysis area: 100 μmφ

### (Maleic Anhydride Acid Modification Ratio of Polypropylene)

The maleic anhydride acid modification ratio of the polypropylene was calculated by converting the mass of the carboxyl group measured from the peak area of 1710 cm⁻¹ by an infrared spectroscopic transmission method using “Nicolet8700” manufactured by Thermo Fisher Scientific, Inc. from the average thicknesses of the innermost layers based on an appropriate calibration curve.

### (Evaluation of Tolerance to Nonaqueous Electrolyte Solution)

<Peeling Test after Immersion in Electrolyte Solution>

A peeling test after immersion in the electrolytic solution was performed on Test No. 1 to No. 13. The electrolyte solution was prepared by mixing ethylene carbonate, diethyl carbonate, and dimethyl carbonate in a volume ratio of 1:1:1, and dissolving lithium hexafluorophosphate (LiPF₆) to a concentration of 1.0 mol/L. After the water content of the electrolyte solution was adjusted to 1000 ppm, the nonaqueous electrolyte solution battery lead wires of Test No. 1 to Test No. 13 were immersed in the electrolyte solution, and left in a thermostatic bath at 80° C. for 4 weeks. Then, the peeling tests of Test No. 1 to Test No. 13 after immersion in the electrolytic solution were performed by the following method. One of the lead conductor and the insulating film of each of Test No. 1 to Test No. 13 was cut and bent at 180°, and the resultant was set in a tensile tester (“EX-SX” manufactured by Shimadzu Corporation). The peeling at the interface between the conductor and the insulating film was evaluated by pulling the set cut portion at a pulling speed of 50 mm/min. The results are shown in Table 1.

TABLE 1

| | | | | No. 1 | No. 2 | No. 3 | No. 4 | No. 5 |
|---|---|---|---|---|---|---|---|---|
| Nonaqueous | Conductor | | Composition | Nickel- | Nickel- | Nickel- | Nickel- | Nickel- |
| Electrolyte | | | | Plated | Plated | Plated | Plated | Plated |
| Lead Wire | | | | Copper | Copper | Copper | Copper | Copper |
| | | | Average Thickness [mm] | 0.2 | 0.2 | 0.2 | 0.2 | 0.2 |
| | Conductor Film | | Composition | Cr, Ni, | Cr, Ni, | Cr, Ni, | Cr, Ni, | Cr, Ni, |
| | | | | O | O | O | O | O |
| | | | Average Thickness [nm] | 4 | 4 | 4 | 4 | 4 |
| | | | Mass of Chromium per Unit Area | 3.0 | 3.0 | 3.0 | 3.0 | 3.0 |
| | | | [mg/m²] | | | | | |
| | | | Ratio of Mass of Chromium | 0.40 | 0.40 | 0.40 | 0.40 | 0.40 |
| | | | Contained in Chromium Hydroxide | | | | | |
| | | | per Unit area to Mass of Chromium | | | | | |
| | | | contained in Trivalent Chromium | | | | | |
| | | | Compound per Unit Area in | | | | | |
| | | | Outermost Surface of Conductor | | | | | |
| | Insulating | Innermost | Composition | Maleic | Maleic | Maleic | Maleic | Maleic |
| | Film | Layer | | Anhydride- | Anhydride- | Anhydride- | Anhydride- | Anhydride- |
| | | | | Modified | Modified | Modified | Modified | Modified |
| | | | | Random | Random | Random | Random | Random |
| | | | | PP | PP | PP | PP | PP |
| | | | Maleic Anhydride Acid | 0.01 | 0.06 | 0.18 | 0.48 | 0.60 |
| | | | Modification Amount [% by mass] | | | | | |
| | | | Average Thickness [μm] | 50 | 50 | 50 | 50 | 50 |
| | | First | Material | Random | Random | Random | Random | Random |
| | | Insulating | | PP | PP | PP | PP | PP |
| | | Layer | Average Thickness [μm] | 100 | 100 | 100 | 100 | 100 |

| | | | | | |
|---|---|---|---|---|---|
| Total Average Thickness [μm] | 150 | 150 | 150 | 150 | 150 |

| Evaluation of Tolerance to Nonaqueous Electrolyte Solution | Peeling | No | No | No | Peeling |
|---|---|---|---|---|---|
| Peeling Test after Immersion in Electrolyte Solution | was | Peeling | Peeling | Peeling | was |
| | Observed | | | | Observed |

| | | | | No. 6 | No. 7 | No. 8 | No. 9 |
|---|---|---|---|---|---|---|---|
| Nonaqueous | Conductor | | Composition | Nickel- | Nickel- | Nickel- | Aluminum |
| Electrolyte | | | | Plated | Plated | Plated | |
| Lead Wire | | | | Copper | Copper | Copper | |
| | | | Average Thickness [mm] | 0.2 | 0.2 | 0.2 | 0.4 |
| | Conductor Film | | Composition | Cr, Ni, | Cr, Ni, | Cr, Ni, | Cr, Al, |
| | | | | O | O | O | O |
| | | | Average Thickness [nm] | 4 | 4 | 4 | 13 |
| | | | Mass of Chromium per Unit Area | 3.0 | 3.0 | 3.0 | 10.0 |
| | | | [mg/m²] | | | | |
| | | | Ratio of Mass of Chromium | 0.80 | 0.95 | 0.20 | 0.60 |
| | | | Contained in Chromium Hydroxide | | | | |
| | | | per Unit area to Mass of Chromium | | | | |
| | | | contained in Trivalent Chromium | | | | |
| | | | Compound per Unit Area in | | | | |
| | | | Outermost Surface of Conductor | | | | |
| | Insulating | Innermost | Composition | Maleic | Maleic | Maleic | Maleic |
| | Film | Layer | | Anhydride- | Anhydride- | Anhydride- | Anhydride- |
| | | | | Modified | Modified | Modified | Modified |
| | | | | Random | Random | Random | Random |
| | | | | PP | PP | PP | PP |
| | | | Maleic Anhydride Acid | 0.18 | 0.18 | 0.18 | 0.18 |
| | | | Modification Amount [% by mass] | | | | |
| | | | Average Thickness [μm] | 50 | 50 | 50 | 50 |
| | | First | Material | Random | Random | Random | Random |
| | | Insulating | | PP | PP | PP | PP |
| | | Layer | Average Thickness [μm] | 100 | 100 | 100 | 100 |

| | | | | |
|---|---|---|---|---|
| Total Average Thickness [μm] | 150 | 150 | 150 | 150 |

| | | | | |
|---|---|---|---|---|
| Evaluation of Tolerance to Nonaqueous Electrolyte Solution | No | Peeling | Peeling | No |
| Peeling Test after Immersion in Electrolyte Solution | Peeling | was | was | Peeling |

| | |
|---|---|
| Observed | Observed |

| | | | No. 10 | No. 11 | No. 12 | No. 13 |
|---|---|---|---|---|---|---|
| Nonaqueous | Conductor | Composition | Aluminum | Nickel- | Nickel- | Copper |
| Electrolyte | | | | Plated | Plated | |
| Lead Wire | | | | Copper | Copper | |
| | | Average Thickness [mm] | 0.4 | 0.2 | 0.2 | 0.2 |

| Conductor Film | | Composition | Cr, Al, | Cr, Ni, | Cr, Ni, | Cr, Cu, |
|---|---|---|---|---|---|---|
| | | | F, O | Ca, O | Ca, O | O |
| | | Average Thickness [nm] | 22 | 6 | 6 | 4 |
| | | Mass of Chromium per Unit Area | 15.0 | 3.0 | 3.0 | 3.0 |
| | | [mg/m²] | | | | |
| | | Ratio of Mass of Chromium | 0.40 | 0.50 | 0.20 | 0.40 |
| | | Contained in Chromium Hydroxide | | | | |
| | | per Unit area to Mass of Chromium | | | | |
| | | contained in Trivalent Chromium | | | | |
| | | Compound per Unit Area in | | | | |
| | | Outermost Surface of Conductor | | | | |
| Insulating | Innermost | Composition | Maleic | Maleic | Maleic | Maleic |
| Film | Layer | | Anhydride- | Anhydride- | Anhydride- | Anhydride- |
| | | | Modified | Modified | Modified | Modified |
| | | | Random | Random | Random | Random |
| | | | PP | PP | PP | PP |
| | | Maleic Anhydride Acid | 0.18 | 0.06 | 0.06 | 0.18 |
| | | Modification Amount [% by mass] | | | | |
| | | Average Thickness [μm] | 50 | 50 | 50 | 50 |
| | First | Material | Random | Random | Random | Random |
| | Insulating | | PP | PP | PP | PP |
| | Layer | Average Thickness [μm] | 100 | 100 | 100 | 100 |

| | | | | |
|---|---|---|---|---|
| Total Average Thickness [μm] | 150 | 150 | 150 | 150 |

| | | | | |
|---|---|---|---|---|
| Evaluation of Tolerance to Nonaqueous Electrolyte Solution | No | No | Peeling | No |
| Peeling Test after Immersion in Electrolyte Solution | Peeling | Peeling | was | Peeling |

Observed

As shown in Table 1, in the nonaqueous electrolyte solution battery lead wire, in Test No. 2 to Test No. 4, Test No. 6, Test No. 9 to Test No. 11, and Test No. 13 in which the conductor was covered with the conductor film contains a trivalent chromium compound including chromium hydroxide and a metal element, the innermost layer of the insulating film stacked on the surface of the conductor film contains, as a main component, a resin component including maleic anhydride-modified polypropylene, and the acid modification ratio of the resin component was 0.02% by mass to 0.50% by mass, no peeling occurred at the interface between the conductor and the insulating film in the peeling test, and the tolerance to the nonaqueous electrolyte solution was good.

In Test No. 1 in which the acid modification ratio of the resin component as the main component of the innermost layer was less than 0.02% by mass, Test No. 5 in which the acid modification ratio of the resin component was more than 0.50% by mass, Test No. 7 in which the ratio of the mass per unit area of the chromium contained in the chromium hydroxide to the mass per unit area of the chromium contained in the trivalent chromium compound on the outermost surface of the conductor film was more than 0.90, and Test No. 8 and Test No. 12 in which the ratio of the mass per unit area of the chromium contained in the chromium hydroxide to the mass per unit area of the chromium contained in the trivalent chromium compound was less than 0.30, peeling was observed at the interface between the conductor and the insulating film in the peeling test, and the tolerance to the nonaqueous electrolyte solution was poor.

The above results show that the nonaqueous electrolyte solution battery lead wire has excellent tolerance to the nonaqueous electrolyte solution of the nonaqueous electrolyte solution battery.

### REFERENCE SIGNS LIST

1 nonaqueous electrolyte solution battery lead wire
3 conductor
4a one end
4b other end
5 insulating film
6 innermost layer
7 second insulating layer
8 first insulating layer
9 conductor film
10 nonaqueous electrolyte solution battery
11 enclosing container
13 seal portion
14 internal connection lead wire
15 solder portion
25 metal layer
26 outermost resin layer
27 innermost resin layer

1. A nonaqueous electrolyte solution battery lead wire comprising:
a conductor; and
an insulating film having one or a plurality of layers and covering at least part of an outer peripheral surface of the conductor,
wherein the conductor has a conductor film covering at least part of a surface thereof,
the conductor film contains a trivalent chromium compound including chromium hydroxide and a metal element,
a ratio of a mass of chromium contained in the chromium hydroxide per unit area [mg/m²] to a mass of chromium contained in the trivalent chromium compound per unit area [mg/m²] is 0.30 to 0.90 at an outermost surface of the conductor film,
the insulating film has an innermost layer stacked on a surface of the conductor film,
the innermost layer contains, as a main component, a resin component including maleic anhydride-modified polypropylene, and
an acid modification ratio of the resin component is 0.02% by mass to 0.50% by mass.

2. The nonaqueous electrolyte solution battery lead wire according to claim 1, wherein the metal element is nickel, aluminum, copper, or a combination thereof.

3. The nonaqueous electrolyte solution battery lead wire according to claim 1, wherein the conductor film further contains a calcium compound, a fluorine compound, or a combination thereof.

4. The nonaqueous electrolyte solution battery lead wire according to claim 1, wherein the acid modification ratio of the resin component is 0.10% by mass to 0.50% by mass.

5. The nonaqueous electrolyte solution battery lead wire according to claim 1, wherein the conductor film has an average thickness of 1 nm to 50 nm.

6. The nonaqueous electrolyte solution battery lead wire according to claim 1, wherein the insulating film has an average thickness of 0.05 mm to 0.50 mm.

7. The nonaqueous electrolyte solution battery lead wire according to claim 1, wherein the innermost layer has an average thickness of 0.01 mm to 0.25 mm.

8. The nonaqueous electrolyte solution battery lead wire according to claim 1, wherein the conductor is nickel, nickel-plated metal, nickel-phosphorus alloy-plated metal, aluminum, or aluminum alloy.

9. A nonaqueous electrolyte solution battery comprising:
an enclosing container;
a plurality of the nonaqueous electrolyte solution battery lead wires according to claim 1 disposed so as to extend from an inside to an outside of the enclosing container; and
a nonaqueous electrolyte solution.
